(19) United States
(12) Patent Application Publication
(10) Pub. No.: US 2003/0069793 A1
(43) Pub. Date: Apr. 10, 2003

(54) Tax Stamp Authentication And Product Control

(76) Inventors: Mr. Richard F Rudolph, Loveland, OH (US); Mr. Thomas J O@$apos;Brien, Charlotte, NC (US); Mr. John P Soehnlen, Loveland, OH (US)

Correspondence Address: Gibbons, Del Deo, Dolan,, Griffinger and Vecchione, One Riverfront Plaza, Newark, NJ, 07102, US

(21) Appl. No.: 09/837,613

(22) Filed: Apr. 17, 2001

Related U.S. Application Data
(60) Provisional application No. 60/197, 875, filed on Apr. 17, 2000.

(51) Int. Cl. G06F 17/60

(52) U.S. Cl. 705/19

(57) ABSTRACT

### Abstract of Disclosure

A product tax stamping system comprising a product tag attached to a product, the product tag containing tax payment information, a remote reading device for accessing the tax payment information from the product tag, and a processor operatively connected to the remote reading device. The processor is controlled by software that provides a tax authentication engine. The remote reading device transfers the tax payment information to the processor for processing by the tax authentication engine.

### Cross Reference to Related Applications

This application claims priority from U.S. Provisional Application Serial No. 60/197,875 which was filed on April 17, 2000 and is incorporated by reference.

### Field of Invention

This invention relates to the field of packaging, and more particularly to a package interfacing to a computer system.

### Background of Invention

Currently, there is a problem with counterfeiting and diversion of cigarette products around the world, which is related at least in part, to the taxes placed upon cigarettes. The differences in taxes create an opportunity for smugglers who can make a profit by buying cigarettes in one jurisdiction where they are cheap and sell them in another jurisdiction where they are expensive. The greater the tax and price differential between jurisdictions, the more profitable and prevalent smuggling becomes.

Many jurisdictions require that cigarette packs be marked with a tax stamp. The current system for tax stamping requires that the cartons be opened, and a printed tax stamp attached to each individual pack of cigarettes. Thus, there is a need to provide a secure system for tax stamping cigarette products and controlling their distribution. This would assist in the prevention of illegal activities relating to collection of cigarette revenues and provide evidence that tax on each item has been paid. In addition, the system should deter smuggling or forgery

### Summary of Invention

The present invention is a product tax authentication system comprising a product tag attached to a product, with the product tag containing tax payment information, a remote reading device for accessing the tax payment information from the product tag, and a processor operatively connected to the remote reading device. The processor is controlled by software, which provides a tax authentication engine. The remote reading device transfers the tax payment information to the processor for processing by the tax authentication engine.

In one embodiment, the present invention is a system utilizing an RFID tag, wherein the RFID tag is programmed with tax payment information. In response to a query, the RFID tag communicates the tax payment information, which is used to verify tax compliance requirements for the product.

The present invention includes methods for verifying tax compliance requirements, tracking distribution channels, deterring unauthorized sales to minors, and detecting counterfeit products.

### Brief Description of Drawings

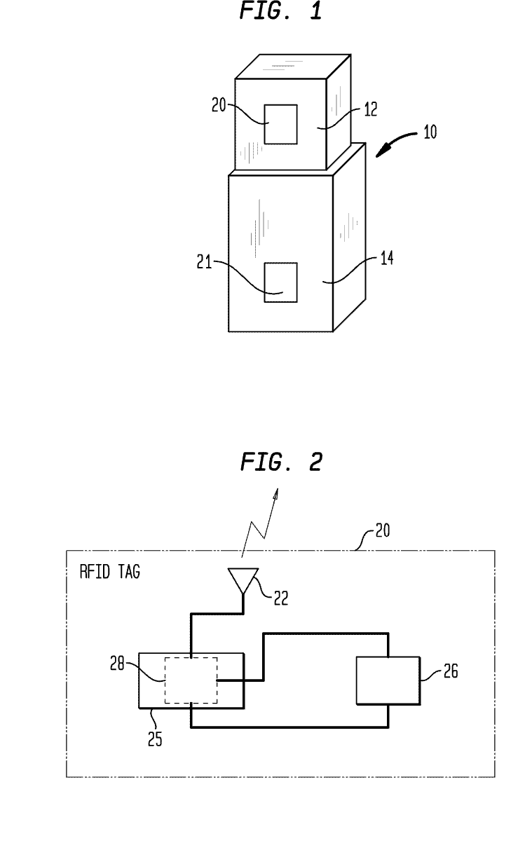

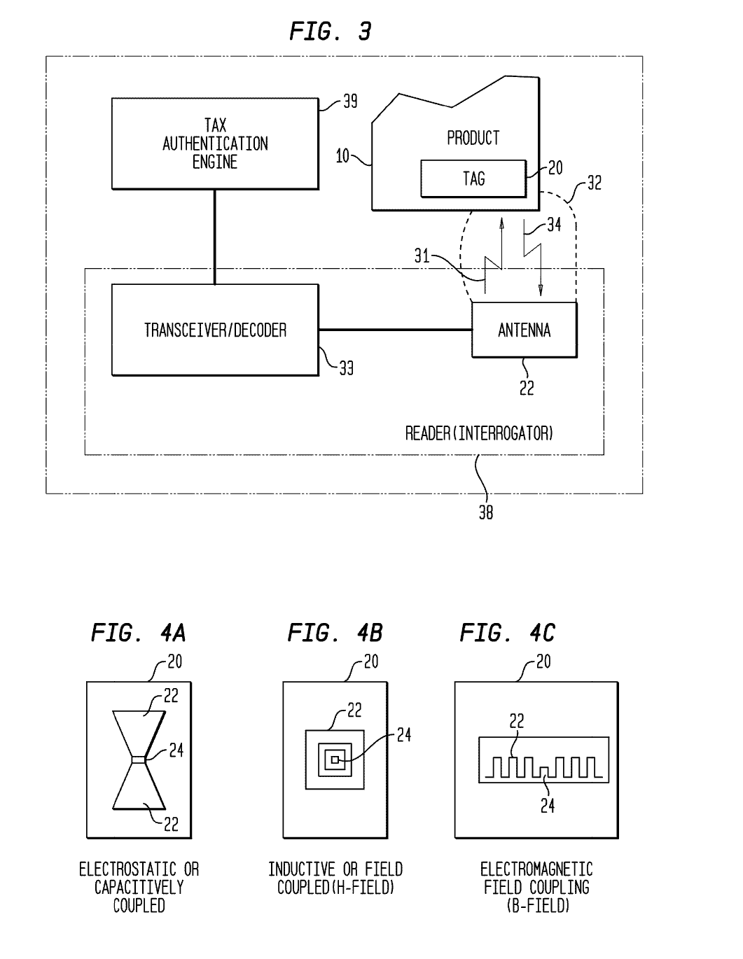

A more complete understanding of the present invention may be obtained from consideration of the following description in conjunction with the drawings in which:FIG. 1 is an overview of a product employing the present invention; FIG. 2 is detailed functional overview of an RFID tag which contains tax related information;FIG. 3 is a functional block diagram of a radio frequency identification system; FIGs. 4a, 4b and 4c are various embodiments of the RFID tag; andFIG. 5 is a flow diagram of a cigarette manufacturing process employing the present invention.

### Detailed Description

A product tax stamping system is disclosed that is comprised of several components. One component of the system is a product tag, which is attached to a product, such as for example, a cigarette pack. Preferably, the product tag is a radio frequency identification (RFID) tag that contains tax payment information, which is used to calculate and/or verify tax compliance requirements in a jurisdiction.

The tax payment information may be any information that can be used for the purpose of authenticating, taxing, complying with governmental obligations, and combinations thereof. Preferably, the tax payment information may be in the form of derivative data, which is derived from raw data or information.

The raw data may relate to the manufacturer"s identity, the distributor, the date and/or location where taxes have been paid, other government identifiers, and the like. To produce derivative data, raw data is manipulated to generate a string or code. For example, a mathematical algorithm may be used to convert the raw data to a string or code.

Additionally, the tax payment information may be in unencrypted or encrypted form. To increase the level of security of the system, it is preferred that the tax payment information be in encrypted form.

Another component is a remote reading device, such as an interrogator, used to access the tax related information from the product tag. Preferably, the remote reading device transfers the tax payment information to a processor for processing by a tax authentication engine. This may be accomplished by a variety of means, including but not limited to, wireless transmission.

The remote reading device is operatively connected to a processor. The processor may be, for example, a computer system, a personal digital assistant, or any electronic device capable of processing information, under the control of computer programs (software). The processor is operatively controlled by a software program that creates a tax authentication engine, which analyzes the tax related information. Doing so enables a user or operator to determine whether the product has satisfied tax compliance requirements for a particular jurisdiction. For example, the tax payment information contained in a single product tag may be used to verify that the appropriate amount of tax has been paid for that particular product.

The system of the present invention has the ability to scan and read information from a product that is in close proximity to or intimate contact with other products. This enables a user or operator to determine whether tax compliance requirements have been satisfied for a particular jurisdiction, simply by scanning a stack of products, such as cigarette packs, cartons or cases stacked on a pallet. The system of the present invention overcomes the limitations or prior art systems, which lacked the ability to effectively gather and discriminate between information placed upon products packaged in close proximity.

The product tax authentication system can be setup as a discrete system, i.e. stand alone or linked to a central database, which is accessed through the processor. The central database would contain information and records that could verify and authenticate tax compliance. For added security, an identification key may be required to access the central database.

As evident, the utility of the system of the present invention can be used to meet government obligations that are placed on particular products. For example, in addition to providing a means to ensure that taxes are paid in a jurisdiction at the point of sale, the system can be used to deter the sale of certain products to minors, or the tax related information can be used to verify that a product has not been tampered or altered.

Although the present invention is particularly well suited for authentication of tax for cigarettes, and shall be so described, the present invention is equally well suited for use in controlling tax or analogous payments and in controlling access for other packaged products.

Referring to FIG. 1, a functional overview of a system employing the present invention is shown. Cigarette package 10, has an inner white liner 12 and an outer printed carton 14. One or more RFID tags 20, 21 can be applied to the sides, front, or bottom of liner 12, as well as to the inner surface front, back, sides or bottom of the outer printed carton 14. RFID 20, 21 are shown in alternative locations. In a typical embodiment, only one RFID tag 20, 21 customarily would be used per cigarette package 10. To comply with industry standards, the RFID tags 20, 21 should be odor free in order to pass tobacco odor and taste panels.

Referring to FIG. 2, an RFID tag 20 which contains tax related information is shown. RFID tag 20 comprises an antenna 22, a transponder 25 and an optional energy storage device 26. The RFID tag 20, in response to being interrogated, transmits the tax related information stored in memory 28, to an interrogator (not shown). The tax related information is conveyed to a processor, preferably through wireless transmission. A software program used in the processor, e.g. computer system, analyzes the tax related information contained in the product tag. The analysis can be used to verify that tax compliance requirements for each particular jurisdiction have been satisfied for the product or that the product is genuine and not counterfeit.

In FIG. 3, a Radio Frequency Identification (RFID) system is shown with an antenna or coil 22, a transceiver (with decoder) 33, and a transponder (commonly called an RF tag) 20 programmed with unique information (data) or derivative data.

The antenna 22 receives and sends radio signals to activate the tag 20 and to read and write data from and to the tag 20. Antenna 22 may be any one of a variety of shapes and sizes. For example, antenna 22 can be built into a doorway to receive tag data from persons or things passing through the door. An electromagnetic field produced by antenna 22 can be constantly present when multiple tags 20 are expected continually. If constant interrogation is not required, a sensor device can activate the field.

Often the antenna 22 is configured with the transceiver/decoder 33 to become a reader (interrogator) 38, which can be configured either as a handheld or a fixed-mount device. The reader 38 emits radio waves 31 across distances of anywhere from one inch to one hundred feet or more, depending upon the signal power output and the radio frequency used. When an RFID tag 20 passes through an electromagnetic sensing zone 32, tag 20 detects the activation signal of reader 38 and responds by emitting radio waves 34. The reader 38 decodes the data encoded in a memory of an integrated circuit of tag 20 and the data is passed to a host processor, e.g. computer, for processing.

RFID tag 20 may be implemented comes in a wide variety of shapes and sizes. RFID tags 20 are categorized as either active or passive. Active RFID tags 20 may be powered by an internal battery (not shown) and are typically read/write, i.e., tag data can be rewritten and/or modified. An active tag memory size varies according to application requirements. Some systems for example operate, with 1MB of memory. In a typical read/write RFID system, a tag 20 can provide a set of instructions or information, and the tag 20 can receive encoded information. This encoded data then becomes part of the history of the tagged product 10. The battery-supplied power of an active tag 20 generally gives it a longer read range. The trade off is greater size, greater cost, and a limited operational life.

Passive RFID tags 20 operate without a separate external power source and obtain operational power generated from reader 38. Passive tags 20 consequently are usually lighter in weight than active tags 20, are less expensive, and offer a virtually unlimited operational lifetime. The trade off is that passive tags 20 have shorter read ranges than active tags and require a higher-powered reader.

Read-only tags 20 are typically passive and are programmed with a unique set of data (usually 32 to 128 bits) that cannot be modified. Read-only tags 20 most often operate as a key or index into a database.

Frequency ranges also distinguish RFID systems. Low-frequency (30kHz to 500kHz) systems typically have short reading ranges and lower system costs. They are most commonly used in security access, asset tracking, and animal identification applications. High-frequency (850 mHz to 950 mHz and 2.4 gHz to 2.5 gHz) systems typically offer long read ranges (greater than 90 feet) and high reading speeds.

A significant advantage of RFID systems is the non-contact, non-line-of-sight nature of the technology. Tags 20 can be read through a variety of substances such as snow, fog, ice, paint, crusted grime, and other visually and environmentally challenging conditions, where barcodes or other optically read technologies would be less effective. RFID tags 20 can also be read in challenging circumstances at high speeds, in most cases responding in less than 100 milliseconds.

The range that can be achieved with an RFID system is determined essentially by the power available at the reader/interrogator 38 to communicate with the tag(s) 20, the power available within the tag 20 to respond, and environmental conditions and structure, the former being more significant at higher frequencies.

Although the level of available power is a primary determinant of range, the manner and efficiency with which that power is deployed also influences the range. The field or wave delivered from an antenna extends into the space surrounding it and its strength diminishes with respect to distance. The antenna design will determine the shape of the field or propagation wave delivered, so that range will also be influenced by the angle subtended between the tag and antenna.

In space free of any obstructions or absorption mechanisms, the strength of a field declines in inverse proportion to the square of the distance between transmitter and receiver. For a wave propagating through a region in which reflections can arise form the ground and from obstacles, the reduction in signal strength can vary quite considerably between transmitter and receiver. In some cases, signal strength may vary as an inverse fourth power of the distance. Where different propagation paths arise, the phenomenon is known as multi-path attenuation. At higher frequencies, absorption due to the presence of moisture can further influence range. It is therefore important in many applications to determine how the environment, internal or external, can influence the range of communication. Where a number of reflective metal "obstacles" are encountered within the application to be considered, and can vary in number from time to time, it may also be necessary to establish the implications of such changes through an appropriate environmental evaluation.

The unique information data is transmitted to tax authentication engine 39, which analyzes the information for tax compliance.

Referring to FIGs. 4a, 4b, and 4c there are shown three embodiments of an RFID tag 20. Antenna 22 can be printed using a conductive ink, conductive resin, polymer, and the like, and be coupled to a radio frequency integrated circuit (RFIC) 24. FIG. 4a shows an electrostatic or capacitively coupled RFID tag. FIG. 4b shows an inductive or H-Field coupled RFID tag. FIG. 4c shows an electromagnetic field coupled (B-Field) RFID tag. The antenna 22 may be rotated from 0°to 180from the position shown in FIGs. 4a, 4b, and 4c.

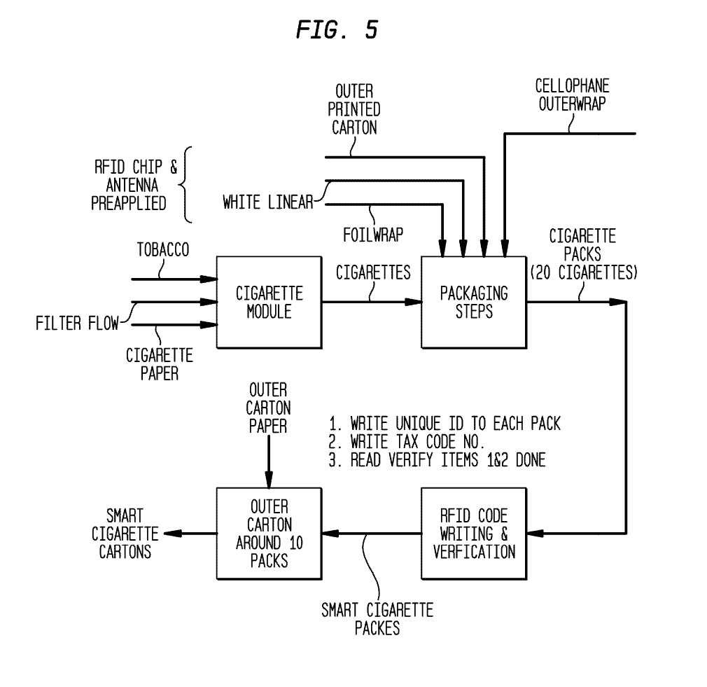

Referring to FIG. 5 there is shown a flow diagram of the application of the present invention in cigarette packaging. The RFID tag is encoded with a unique identification code for each pack, which may be encrypted for added security. Tax payment (compliance) information is added to the RFID tag when payment verification is effected. The RFID tag can be applied to the cigarette pack, during the packaging operation.

Placing an RFID tag on a product enables tax verification can be accomplished without requiring cartons to be opened.includes a method for verifying tax compliance requirements for a product. The method comprises the steps of: (i) providing a product tax stamping system comprising a product tag attached to a product, the product tag having tax related information, a remote reading device for accessing the tax related information from the product tag, and a processor operatively connected to the remote reading device and adapted under the control of software to include a taxation engine, wherein the remote reading device transfers the tax related information to the processor for processing by the taxation engine; (ii) sending a query signal from the remote reading device to the product tag; (iii) responding to the query signal by communicating the tax related information from the product tag to the processor; and (iv) verifying tax compliance of the tax related information from the product tag.

The RFID tag also allows traceability of distribution of a product, such as cigarettes, thus enabling control of distribution through electronic article surveillance. Customs agents and others can use hand held interrogators to detect, read and decode the RFID tag to determine proper distribution and authentication of product. Furthermore, electronic article surveillance can be enhanced to detect specific packages and thus not be triggered by an authorized purchase. In this embodiment, the present invention comprises a method for tracking distribution channels of a product. The method comprises the steps of: (i) providing a product tax stamping system comprising a product tag attached to a product, the product tag having tax related information and product identification information, a remote reading device for accessing the tax related information from the product tag, and a processor operatively connected to the remote reading device and adapted under the control of software to include a taxation engine, wherein the remote reading device transfers the tax related information to the processor for processing by the taxation engine; (ii) sending a query signal from the remote reading device to the product tag; (iii) responding to the query signal by communicating the tax related information from the product tag to the processor; and (iv) tracking the product by reading the tax related information and identification information from the product tag.

In another embodiment, the traceability feature of the present invention comprises a method for detecting counterfeit products. The method comprises the steps of (i) providing a product tax stamping system comprising: a product tag attached to a product, the product tag having tax related information, a remote reading device for accessing the tax related information from the product tag, and a processor operatively connected to the remote reading device and adapted under the control of software to include a taxation engine, wherein the remote reading device transfers the tax related information to the processor for processing by the taxation engine; (ii) sending a query signal from the remote reading device to the product tag; (iii) responding to the query signal by communicating the tax related information from the product tag to the processor; (iv) verifying the tax related information complies with tax compliance requirements of a jurisdiction; and (v) determining whether the product is counterfeit based upon the verification step.

In yet another embodiment of the present invention, the sale of a product to minors can be restricted by having a Point Of Sale terminal prompt an operator to request identification verification prior to processing or completing the transaction. In this embodiment, the present invention comprises a method for deterring unauthorized sales to minors of a product comprising the steps of (i) providing a product identifier system comprising: a product tag attached to a product, the product tag having identifier information, a remote reading device for accessing the identifier information from the product tag, and a processor operatively connected to the remote reading device and adapted under the control of software to include an authentication engine, wherein the remote reading device transfers the identifier information to the processor for processing by the authentication engine; (ii) sending a query signal from the remote reading device to the product tag; (iii) responding to the query signal by communicating the identifier information from the product tag to the processor; and (iv) prompting a user to request age verification identification from a consumer purchasing the product.

In view of the foregoing description, numerous modifications and alternative embodiments of the invention will be apparent to those skilled in the art. Accordingly, this description is to be construed as illustrative only and is for the purpose of teaching those skilled in the art the best mode of carrying out the invention. Details of the structure may be varied substantially without departing from the invention.

Claims

1.A product tax stamping system comprising:
a product tag associated with a product, said product tag having tax payment information;
a remote reading device for accessing said tax payment information from said product tag; and
a processor operatively connected to said remote reading device and adapted under the control of software to include a tax authentication engine;
wherein said remote reading device transfers said tax related information to said processor for processing by said taxation engine.

2.The system of claim 1, wherein said product tag is a radio frequency identification transponder.

3.The system of claim 1, wherein said tax authentication engine accesses a database to obtain verification of taxation requirements in a jurisdiction.

4.The system of claim 1, wherein said tax payment information is wirelessly transmitted from said remote reading device to said processor.

5.The system of claim 1, wherein said product tag is attached to said product as a label.

6.The system of claim 1, wherein said product tag is attached to said product as an embedded chip.

7.The system of claim 1, wherein said product tag further comprises an antenna made from a material selected from the group consisting of conductive inks, resins, polymers, and mixtures thereof.

8.The system of claim 7, wherein said antenna is selected from the group consisting of electrostatic capacitively coupled, inductive field coupled, and electromagnetic field coupled.

9.A method for verifying tax compliance requirements for a product, comprising the steps of:
(i) providing a product tax stamping system comprising:
a product tag attached to a product, said product tag having tax related information;
a remote reading device for accessing said tax related information from said product tag; and
a processor operatively connected to said remote reading device and adapted under the control of software to include a taxation engine;
wherein said remote reading device transfers said tax related information to said processor for processing by said taxation engine;
(ii) sending a query signal from said remote reading device to said product tag;
(iii) responding to said query signal by communicating said tax related information from said product tag to said processor; and
(iv) verifying tax compliance of said tax related information from said product tag.

10.The method of claim 9, wherein said product tag is an RFID transponder.

11.The method of claim 9, wherein said tax related information is wirelessly transmitted from said remote reading device to said processor.

12.The method of claim 9, wherein said product tag is attached to said product as a label or as an embedded chip.

13.The method of claim 9, wherein said product tag further comprises an antenna made from a material selected from the group consisting of conductive inks, resins, polymers, and mixtures thereof.

14.The method of claim 13, wherein said antenna is selected from the group consisting of electrostatic capacitively coupled, inductive field coupled, and electromagnetic field coupled.

15.A method for tracking distribution channels of a product, comprising the steps of:
(i) providing a product identifier system comprising:
a product tag attached to a product, said product tag having identifier information;
a remote reading device for accessing said identifier information from said product tag; and
a processor operatively connected to said remote reading device and adapted under the control of software to include an authentication engine;
wherein said remote reading device transfers said identifier information to said processor for processing by said authentication engine;
(ii) sending a query signal from said remote reading device to said product tag;
(iii) responding to said query signal by communicating said identifier information from said product tag to said processor; and
(iv) tracking said product by reading said identifier information from said product tag.

16.The method according to claim 15, further including the step of recording said user verification data in association with identifier information from said product.

17.A method for deterring unauthorized sales to minors of a product, comprising the steps of:
(i) providing a product tax stamping system comprising:
a product tag attached to a product, said product tag having tax related information;
a remote reading device for accessing said tax related information from said product tag; and
a processor operatively connected to said remote reading device and adapted under the control of software to include a taxation engine;
wherein said remote reading device transfers said tax related information to said processor for processing by said taxation engine;
(ii) sending a query signal from said remote reading device to said product tag;
(iii) responding to said query signal by communicating said tax related information from said product tag to said processor; and
(iv) prompting a user to request age verification identification from a consumer purchasing said product.

18.A method for detecting counterfeit products, comprising the steps of:
(i) providing a product tax stamping system comprising:
a product tag attached to a product, said product tag having tax related information;
a remote reading device for accessing said tax related information from said product tag; and
a processor operatively connected to said remote reading device and adapted under the control of software to include a taxation engine;
wherein said remote reading device transfers said tax related information to said processor for processing by said taxation engine;
(ii) sending a query signal from said remote reading device to said product tag;
(iii) responding to said query signal by communicating said tax related information from said product tag to said processor;
(iv) verifying said tax related information complies with tax compliance requirements of a jurisdiction; and
(v) determining whether said product is counterfeit based upon said verification step.

19.A product tax stamping system comprising:
an RFID tag attached to a product, said RFID tag having tax related information;
a remote reading device for accessing said tax related information from said RFID tag; and
a processor operatively connected to said remote reading device and adapted under the control of software to include a taxation engine;
wherein said remote reading device transfers said tax related information to said processor for processing by said taxation engine.

20.A tax stamp authentication system for use in authenticating a product, said system comprising:
at least one RFID tag having verification information affixed to said product;
an interrogator adapted to read said tax verification information;
a tax authentication engine adapted to receive said tax verification information from said interrogator and authenticate tax compliance of said product.

21.The system of claim 20, wherein said product is of pack of cigarettes;
said tax verification information includes at least one data field selected from the group consisting of: manufacturer"s identifier, distributor identifier, pallet identifier, carton identifier, tax payment date, tax payment location, tax payment state, and cigarette pack identifier.

22.The system of claim 20, wherein said tax verification information is unique for each product.

23.The system of claim 20, wherein said tax verification information is encrypted.

24.The system of claim 21, wherein said tax verification information is derivative data from at least two data fields.

25.The system of claim 20, 21, 23 or 24 wherein said tax authentication engine is adapted to authenticate tax compliance of said product from said tax verification data.

26.The system of claim 20, 21, 23, or 24 further including: a tax compliance database connected to said tax authentication engine; and
said tax authentication engine adapted to authenticate tax compliance based upon a comparison of said tax compliance database with said tax verification information.

27.The system of claim 20, wherein said interrogator and said tax authentication engine are included in a portable unit.

28.The system of claim 20, further including a plurality of products group collectively for shipment;
each producing an RFID tag;
wherein said tax authentication engine is adapted to read each of said RFID tags.

29. The system of claim 20, wherein said tax authentication engine is adapted to verify the age of product purchasers.
